(19) United States
(12) Patent Application Publication
(10) Pub. No.: US 2003/0052860 A1
(43) Pub. Date: Mar. 20, 2003

(54) Modular remote controller

(75) Inventors: Hee-Seon Park, Seoul (KR); Young-Kyu Jin, Goyang-si (KR); Gwi-ho Lee, Seoul (KR); Hye-Ju Kim, Incheon Metropolitan-City (KR)

Correspondence Address: SUGHRUE MION, PLLC, 2100 Pennsylvania Avenue, N.W., Washington, DC, 20037-3213, US

(73) Assignee: Samsung Electronics Co., Ltd.

(21) Appl. No.: 10/218,900

(22) Filed: Aug. 15, 2002

(30) Foreign Application Priority Data
Aug. 17, 2001 (KR) 2001-49599

(51) Int. Cl. G09G 5/00

(52) U.S. Cl. 345/156

(57) ABSTRACT

Provided is a modular remote controller assembled by the connection of modules chosen based on desired functions, wherein each of the modules is constructed for one function of the remote controller. The modular remote controller includes: a main remote controller which generates a remote control signal for remote controlling an electronic apparatus in response to one of an internal control signal, which is internally generated in response to a key input, and an external control signal; and at least one remote controller extension module which is detachably coupled to the main remote controller and generates the external control signal.

### BACKGROUND OF THE INVENTION

1. Field of the Invention

The present invention relates to remote controllers, and more particularly, to a modular remote controller assembled by connecting modules chosen based on desired functions, wherein each of the modules is constructed to perform one function of the remote controller. The present application is based on Korean Patent Application No. 2001-49599, which is incorporated herein by reference.

2. Description of the Related Art

The customized electronics industry has created many stand-alone products for specific functions, such as television viewing, video recording and playback, broadband video receiving, playing recorded music and broadcast music. Recently, multi-functional electronics, such as a home entertainment system disclosed in U.S. Pat. No. 5,675,390 assigned to Schindler (October 1997), are being increasingly manufactured. For example, a variety of functions, such as Internet browsing, MP3 playback, data transmission/reception, etc., are incorporated into a personal digital assistant (PDA), digital camera, digital TV, digital set top box, plasma display panel (PDP) TV, thin film transistor-liquid crystal display (TFT-LCD) TV, etc.

Such functional diversification of electronic devices increases the manufacturing cost and complexity of the structure of a remote controller controlling the operation of the device. For example, to enable web browsing, electronic program guide (EPG) searching, e-mail sending, video chatting, gaming using a TV, the remote controller advantageously inputs various types of data for these functions. Accordingly, the TV remote controller should support various types of data input to provide desired functions. To this end, there is a need to incorporate the function of data input devices, such as a keyboard, joy stick, touch pad, hot key, etc., into the remote controller. These input devices have different user preferences. As the number of functional keys added for those functions increases, the remote controller increases in size and a complicated arrangement of buttons on the remote controller results. Furthermore, handling of the remote controller becomes complicated, and handheld operation is difficult due to the size of the remote controller, which is too large to comfortably hold in the hand.

### SUMMARY OF THE INVENTION

To solve the above-described problems, it is an object of the present invention to provide a modular remote controller capable of being assembled by selective connection of individual modules based on desired functions, wherein each of the modules is constructed to perform one function of the remote controller.

According to an aspect of the present invention, there is provided a remote controller comprising: a key input portion having a plurality of instruction keys with which an instruction to remote control an electronic apparatus is input; a controller which generates a first control signal in response to the instruction input from the key input portion and outputs one of the first control signal and a second control signal which is externally input, as a remote control signal; and a wireless data transmitter which wirelessly transmits the remote control signal to the electronic apparatus.

According to another aspect of the present invention, there is provided a multi-connection type remote controller extension module comprising: a key input portion having at least one instruction key; an input port which externally receives a first control signal for remote controlling an electronic apparatus; a functional circuit which generates a second control signal for remote controlling the electronic apparatus by performing its specific function in response to an instruction input from the key input portion and outputs one of the first control signal and the second control signal; and an output port which externally outputs an output signal of the functional circuit.

According to another aspect of the present invention, there is provided a single-connection type remote controller extension module comprising: a key input portion having at least one instruction key; a functional circuit which generates a control signal for remote controlling an electronic apparatus by performing its specific function in response to an instruction input from the key input portion; and an output port which externally outputs the control signal.

According to another aspect of the present invention, there is provided a modular remote controller comprising: a main remote controller which generates a remote control signal for remote controlling an electronic apparatus in response to one of an internal control signal internally generated in response to a key input, and an external control signal; and a plurality of remote controller extension modules which are selectively coupled to the main remote controller and generate the external control signal.

### BRIEF DESCRIPTION OF THE DRAWINGS

The above object and advantages of the present invention will become more apparent by describing in detail preferred embodiments thereof with reference to the attached drawings in which:

FIG. 1 shows the appearance of a main remote controller according to a preferred embodiment of the present invention;

FIG. 2 shows an example of the attachment of a game pad module and a CCD (charge coupled device) camera module to the main remote controller of FIG. 1 as remote controller extension modules;

FIG. 3 shows the appearance of the main remote controller after the attachment of the game pad module and the CCD camera module of FIG. 2 is complete;

FIGS. 4A through 4F show alternative embodiments of the module extension of the main remote controller of FIG. 1 with different remote controller extension modules for specific functions;

FIG. 5 is a block diagram of the main remote controller according to a preferred embodiment of the present invention;

FIG. 6 is a flowchart illustrating each step of the operation of the main remote controller of FIG. 5;

FIG. 7 is a block diagram of a preferred embodiment of a multi-connection type remote controller extension module according to the present invention;

FIG. 8 is a flowchart illustrating each step of the operation of the multi-connection type remote controller extension module of FIG. 7;

FIG. 9 is a block diagram of another preferred embodiment of the single-connection type remote controller extension module according to the present invention;

FIG. 10 is a flowchart illustrating each step of the operation of the single-connection type remote controller extension module of FIG. 9; and

FIG. 11 shows an example of a modular remote controller according to the present invention where a plurality of remote controller extension modules are connected to the main remote controller.

### DETAILED DESCRIPTION OF THE INVENTION

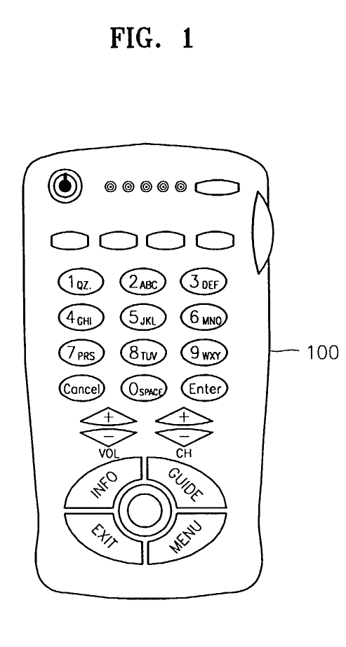

Preferred embodiments of the present invention will be described with reference to the appended drawings. FIG. 1 shows the appearance of a main remote controller 100 according to a preferred embodiment of the present invention. Referring to FIG. 1, the main remote controller 100 includes a plurality of buttons for controlling the basic operation of electronic devices, such as a TV. The plurality of buttons include a power on/off button, channel up/down button, volume up/down button, directional keys for basic menu selection, etc. Since the main remote controller 100 has a minimal function of TV control, its size is small enough for easy manipulation. Other functions may be added to the main remote controller 100 by selectively connecting remote controller extension modules for specific functions.

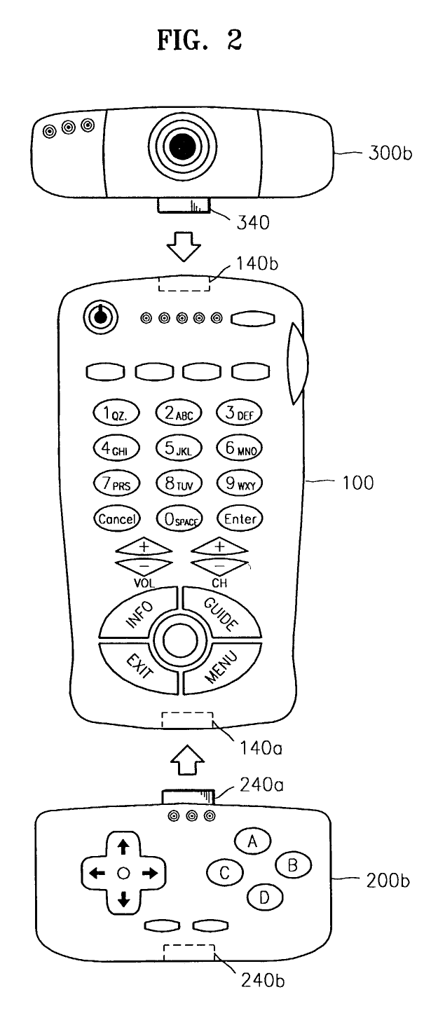

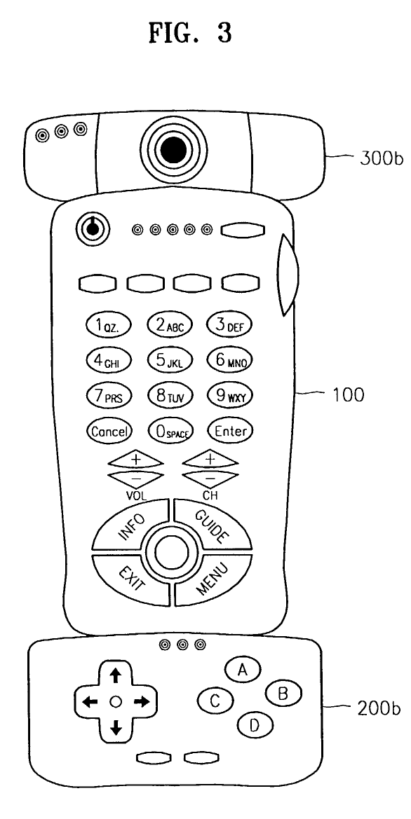

FIG. 2 shows an example of the attachment of a game pad module 200b and a CCD (charge coupled device) camera module 300b to the main remote controller 100 of FIG. 1 as remote controller extension modules. FIG. 3 shows the appearance of the main remote controller 100 after the game pad module 200b and the CCD S camera module 300b have been attached.

Referring to FIGS. 2 and 3, at least one remote controller extension module 200b and 300b are connected to the main remote controller 100 by interface ports 140a, 140b, 240a, 240b, and 340 which support a predetermined protocol. As an example, when the main remote controller 100, the game pad module 200b, and the CCD camera module 300b support a Universal Serial Bus (USB) interface, the USB interface ports 240a and 340 of the respective game pad module 200b and CCD camera module 300b are coupled to the USB interface ports 140a and 140b of the main remote controller 100, respectively, in the direction indicated by the arrows in FIG. 2. As a result, the main remote controller 100 can remote control an electronic device by a control signal generated from itself and a control signal generated from the game pad module 200b or the CCD cameral module 300d.

As an example, when a user wishes to play a game using the TV, the game pad module 200b may be attached to the main remote controller 100 to conveniently control both the basic TV operation and the gaming. As another example, when a user wishes to communicate with another person at a remote site via video chatting using the TV, the transmission of video data obtained using the CCD cameral module 300b as well as the control of the TV operation can be achieved by attaching the CCD camera module 300b, which can provide the video data for video chatting, to the main remote controller 100.

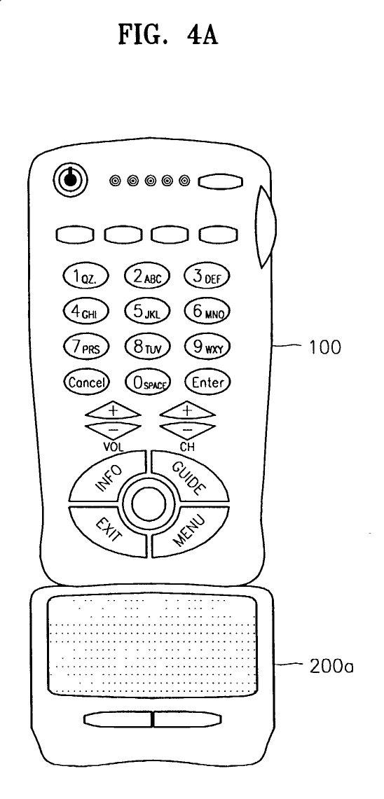

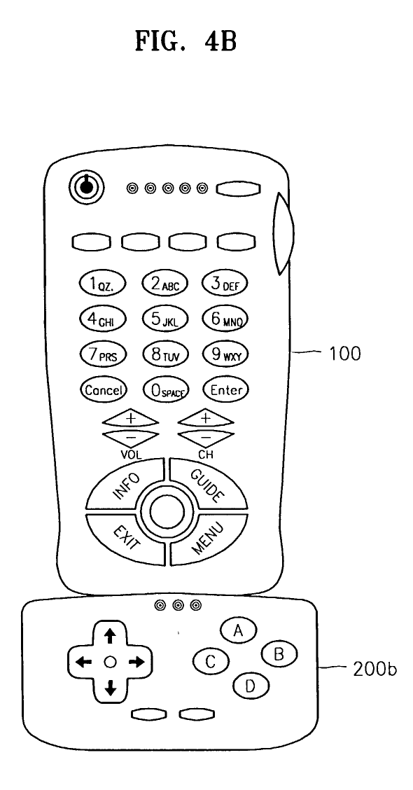

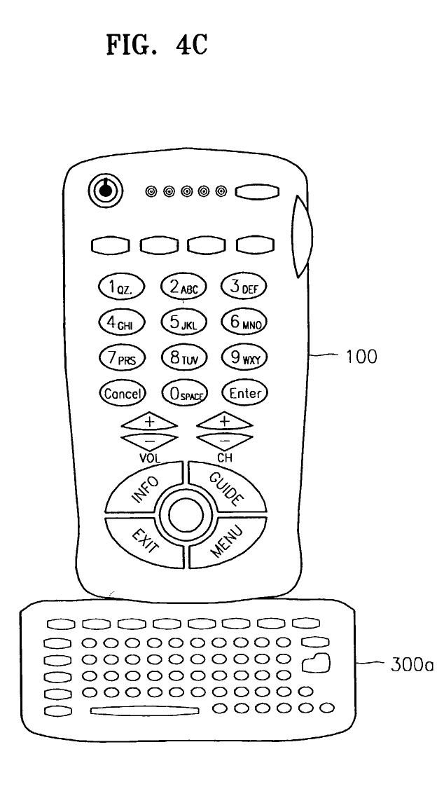

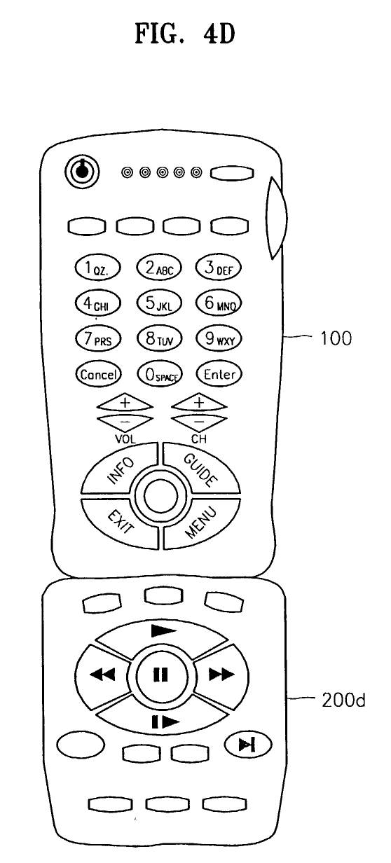

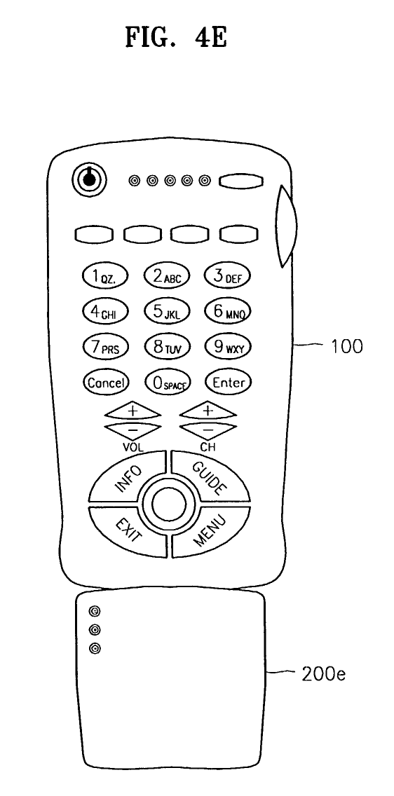

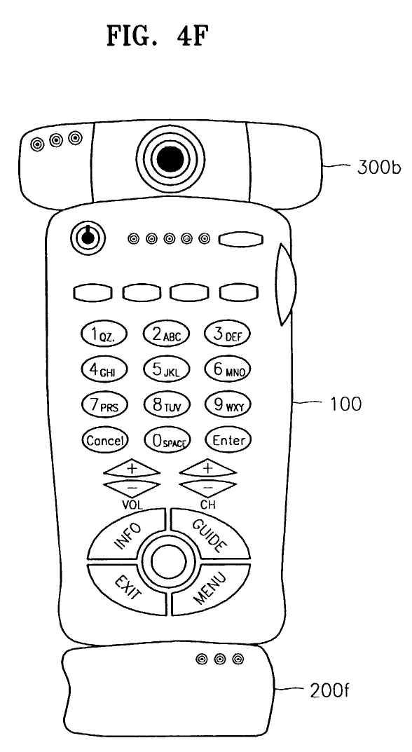

FIGS. 4A through 4F show alternative embodiments of the module extension of the main remote controller 100 of FIG. 1 with different remote controller extension modules for specific functions. Any type of remote controller extension module for a specific function, as well as the game pad module 200b and the CCD camera module 300b of FIG. 3, may be connected to the main remote controller 100. As an example, for easy web browsing or choice of a task from a menu using a TV, a touch-pad module 200a as shown in FIG. 4A may be connected to the main remote controller 100. To play a game using the TV, the game pad module 200b which can generate instruction signals for gaming may be exclusively attached to the main remote controller 100, as shown in FIG. 4B. As another example, for data transmission or chatting using the TV, a keyboard module 300a may be connected to the main remote controller 100, as shown in FIG. 4C, to make text input easier. The keyboard module 300a may be directly connected to the main remote controller 100 by a connector of the interface port, or may be connected to the main remote controller by a cable of a predetermined length.

As another example, when the user wishes to record a TV program while viewing TV, a personal video record (PVR) module 200d may be connected to the main remote controller 100, as shown in FIG. 4D, to control video recording and playback operations. Furthermore, a scanner module 200e may be connected to the main remote controller 100, as shown in FIG. 4E, to transmit a scanned image to the TV. Alternatively, the CCD camera module 300b and a portable media module 200f may be connected to the main remote controller 100, as shown in FIG. 4F, to transmit image data photographed by the CCD camera module 300b and data stored in the portable media module 200f to the TV. One or a plurality of remote controller extension modules may be attached to the main remote controller 100 depending on the user's choice. The number of remote controller extension modules which can be simultaneously attached to the main remote controller 100 varies depending on the interface specification. For example, for the USB interface, up to 127 remote controller extension modules can be attached to one main remote controller 100.

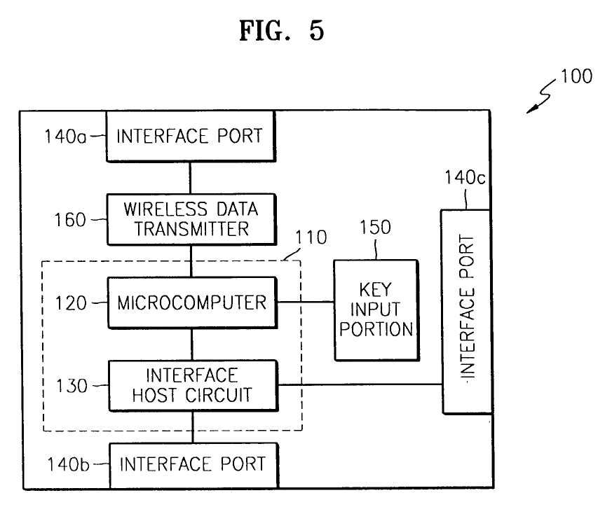

FIG. 5 is a block diagram of the main remote controller 100 according to a preferred embodiment of the present invention. Referring to FIG. 5, the main remote controller 100 includes a key input portion 150 which receives key inputs, interface ports 140a, 140b, and 140c which receives an external control signal, a control unit 110 which generates an internal control signal in response to a key input and generates a remote control signal in response to either the internal control signal or the external control signal, and a wireless data transmitter 160 which wirelessly transmits the remote control signal.

The control unit 110 includes a microcomputer 120 which controls the overall operation of the main remote controller 100 and an interface host circuit 130 which controls interfacing between the main remote controller 100 and a remote controller extension module. Suitable interfaces between the main remote controller 100 and the remote controller extension module may include, but are not limited to, Bluetooth, CompactFlash, and RS232C. The interface host circuit 130 may include circuits that support protocols for those interfaces. For example, when the USB is applied as an interface between the main remote controller 100 and the remote controller extension module, the interface host circuit 130 includes an OHCI (Open Host Controller Interface) or UHCI (Universal Host Controller Interface) circuit supporting the USB interface. While only one microcomputer 120 is incorporated into the control unit 110 in FIG. 5, the structure of FIG. 5 is for illustrative purpose and is not intended to limit the scope of the present invention. A plurality of microcomputers 120 may be used if necessary, by consideration of interfacing between the main remote controller 100 and the remote controller extension module. Alternatively, the microcomputer 120 may be implemented by a central processing unit (CPU).

The interface ports 140a, 140b, and 140c, input/output ports for data transmission/reception, provide electrical connection between the remote controller 100 and the remote controller extension module to allow data transmission or reception therebetween. While three interface ports 140a, 140b, and 140c are illustrated in FIG. 3, one or a plurality of interface ports may be incorporated into the main remote controller 100 depending on the circuit structure. Like the interface host circuit 130, each of the interface ports 140a, 140b, and 140c supports an interfacing protocol such as Bluetooth, CompactFlash, or RS232C. This allows any peripheral devices of a personal computer (PC) using the USB interface or any peripheral devices of a PDA (Personal Data Assistant) using the CompactFlash interface to be readily available as remote controller extension modules by connection to the main remote controller 100. The main remote controller 100 having the structure described above operates as follows.

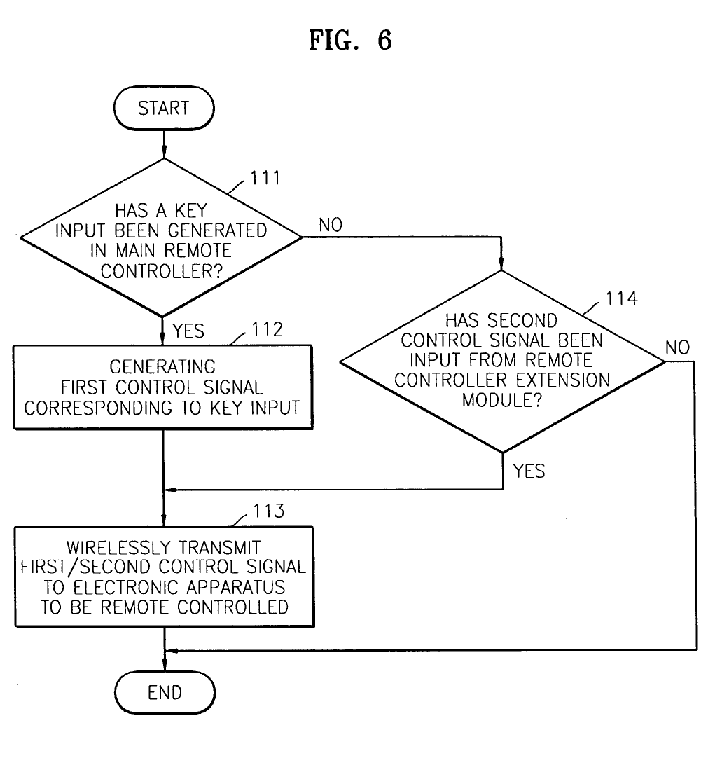

FIG. 6 is a flowchart illustrating each step of the operation of the main remote controller 100 of FIG. 5. Referring to FIG. 6, it is determined whether a key (button) has been input to the main remote controller 100 (Step 111). If it is determined that a key has been input to the main remote controller 100, a first control signal corresponding to a key input is generated (Step 112) and then wirelessly transmitted to an electronic apparatus (Step 113) to be remote controlled by the main remote controller 100. In contrast, if it is determined in Step 111 that there is no key input into the main remote controller 100, it is determined whether a second control signal has been input from the remote controller extension module connected to the main remote controller 100 (Step 114). If it is determined that the second control signal has been input from the remote controller extension module, the input second control signal is wirelessly transmitted to the electronic apparatus (Step 113) to be remote controlled by the main remote controller 100. As described above, the main remote controller 100 according to the present invention wirelessly transmits the first control signal generated by the main remote controller 100 itself and the second control signal generated by the remote controller extension module connected to the main remote controller 100 as a remote control signal to the electronic apparatus.

Remote controller extension modules that can be connected to the main remote controller 100, as described above, are roughly divided into two types: a multi-connection type extension module and a single-connection type extension module. The multi-connection type extension module refers to an extension module having at least two interface ports, such as the game pad module 200b having the interface ports 240a and 240b shown in FIG. 2, which provides connection with another extension module and transmits a control signal generated by itself and a control signal generated by the other extension module to the main remote controller 100. The single-connection type extension module refers to an extension module having one interface port, such as the CCD camera module 300b having one interface port 340 shown in FIG. 2, which transmits only a control signal generated by itself to the main remote controller 100. Each remote controller extension modules may be directly connected to the main remote controller 100 or may be connected to the main remote controller 100 via at least one multi-connection type extension module.

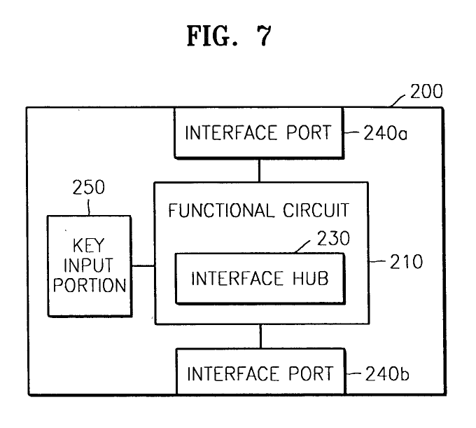

FIG. 7 is a block diagram of a multi-connection type remote controller extension module 200 according to a preferred embodiment of the present invention. Referring to FIG. 7, the multi-connection type remote controller extension module 200 includes a key input portion 250 which receives key inputs, a first interface port 240a which receives an external control signal, a functional circuit 210 which generates an internal control signal for its specific modular function in response to a key input and outputs the internal control signal or the external control signal, and a second interface port 240b which externally outputs an output signal from the functional circuit 210. The functional circuit 210, a circuit performing a particular modular function, such as display, game control, or scanning function, includes an interface hub 230 for interfacing with the interface host circuit 130 of the main remote controller 100. The interface hub 230 provides interfacing between the main remote controller 100 and the remote controller extension module 200 as well as between the main remote controller 100 and another extension module connected to the remote controller extension module 200. More interface ports 240a and 240b may be included depending on the circuit structure. The interface ports 240a and 240b and the interface hub 230 supports an interfacing protocol such as Bluetooth, CompactFlash, or RS232C.

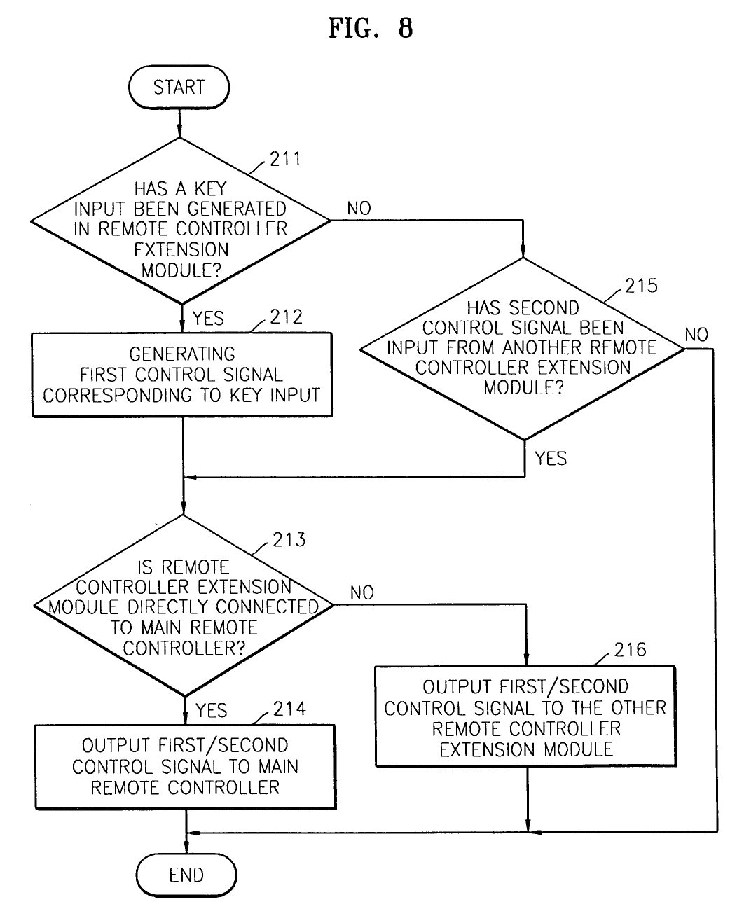

FIG. 8 is a flowchart illustrating each step of the operation of the multi-connection type remote controller extension module 200 of FIG. 7. Referring to FIG. 8, it is determined whether a key has been input to the remote controller extension module 200 (Step 211). If it is determined in Step 211 that a key has been input to the remote controller extension module 200, a first control signal corresponding to a key input is internally generated (Step 212). If there has been no key input into the remote controller extension module 200, it is determined whether a second control signal has been input from another remote controller extension module (Step 215). If there has been a key input from another remote controller extension module, the process proceeds to Step 213. If there has been no key input from another remote controller extension module, the process is terminated.

In Step 213, it is determined whether the remote controller extension module is directly connected to the main remote controller 100. If the remote controller extension module 200 is directly connected to the main remote controller 100, the first control signal generated by the remote controller extension module 200 or the second control signal input from another remote controller extension module is output to the main remote controller 100 (Step 214). If the remote controller extension module 200 is not directly connected to the main remote controller 100, the first control signal generated by the remote controller extension module 200 or the second control signal input from another remote controller extension module is output to the other remote controller extension module connected to the remote controller extension module 200 (Step 216).

As described above, in connection with the main remote controller 100 or at least one remote controller extension module, a multi-connection type remote controller extension module according to the present invention transmits a control signal generated by itself and a control signal generated by another remote controller extension module the main remote controller 100 or another remote controller extension module. As a result, the control signals generated by the remote controller extension modules can be transmitted to the wireless data transmitter 160 of the main remote controller 100 without additional complicated control operation and then to an electronic apparatus to be remote controlled.

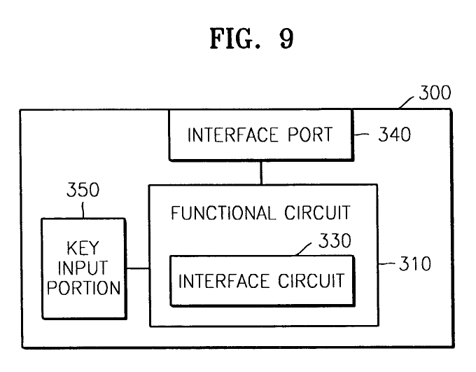

FIG. 9 is a block diagram of a single-connection type remote controller extension module 300 according to another preferred embodiment of the present invention. Referring to FIG. 9, the single-connection type remote controller extension module 300 includes a key input portion 350 which receives key inputs, a functional circuit 310 which generates a control signal for its specific modular function in response to a key input and outputs the control signal, and an interface port 340 which externally outputs the output signal of the functional circuit 310. The functional circuit 310 includes an interface circuit 330 for interfacing with the interface host circuit 130 of the main remote controller 100. The interface circuit 330 transmits, through the interface port 340, the control signal generated by the functional circuit 310 to the main remote controller 100 or another remote controller extension module, such as the multi-connection type remote control module 200. The interface port 340 and the interface circuit 330 support an interfacing protocol such as Bluetooth, CompactFlash, or RS232C.

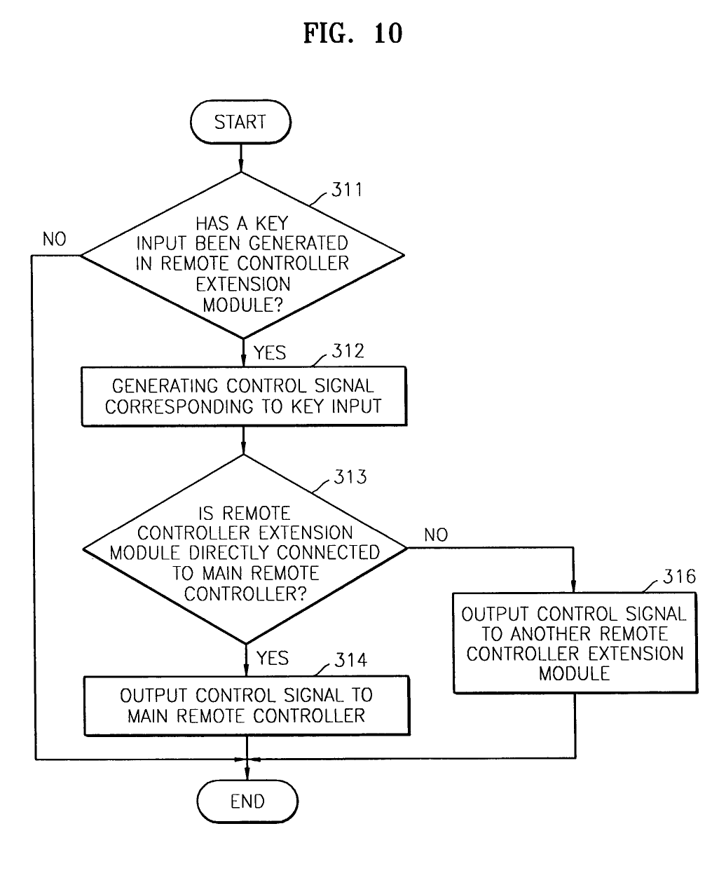

FIG. 10 is a flowchart illustrating each step of the operation of the single-connection type remote controller extension module 300 of FIG. 9. Referring to FIG. 10, it is determined whether a key has been input to the remote controller extension module 300 (Step 311). If it is determined in Step 311 that a key has been input to the remote controller extension module 300, a control signal corresponding to a key input is internally generated (Step 312). Next, it is determined whether the remote controller extension module 300 is directly connected to the main remote controller 100 (Step 313). If the remote controller extension module 300 is directly connected to the main remote controller 100, the control signal generated by the remote controller extension module 300 is output to the main remote controller 100 (Step 314). In contrast, it the remote controller extension module 300 is not directly connected to the main remote controller 100, for example, via another remote controller extension module, the control signal generated by the remote controller extension module 300 is output to the other remote controller extension module (Step 316).

As described above, in connection with the main remote controller 100 or another remote controller extension module, a single-connection type remote controller extension module according to the present invention generates and outputs a control signal to the main remote controller 100 or another remote controller extension module. As a result, the control signal generated by the single-connection type remote controller extension module can be transmitted to the wireless data transmitter 160 of the main remote controller 100 without additional complicated control operation and then to an electronic apparatus to be remote controlled.

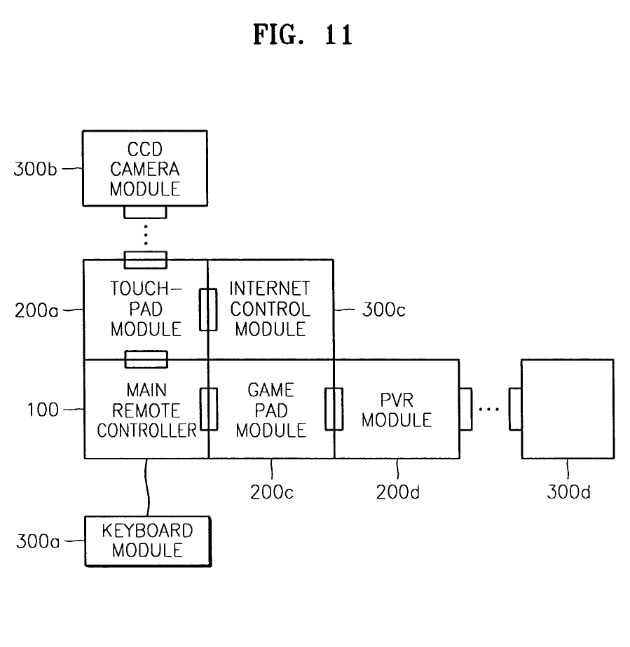

FIG. 11 shows an example of a modular remote controller according to the present invention where a plurality of remote controller extension modules 200a, 200c and 200d and 300a-300d are connected to the main remote controller 100 of FIG. 5. As shown in FIG. 11, more than one multi-connection type remote controller extension modules 200a, 200c and 200d and single-connection type remote controller extension modules 300a-300d may be connected to the main remote controller 100. To this end, a multi-connection type remote controller extension module having the structure shown in FIG. 7 and a single-connection type remote controller extension having the structure shown in FIG. 9 may be directly connected to the main remote controller 100. The multi-connection type remote control modules 200a and 200c connected to the main remote controller 100 by their one interface port may be connected to other multi-connection type remote control modules or single-connection type remote control modules 300b, 300c, and 300d by the other interface port. Here, each of the remote controller extension modules 200a, 200c and 200d and 300a-300d may be connected to the main remote controller 100 by a connector of each of the interface ports, or may be connected to the main remote controller 100 by a cable of a predetermined length, like the keyboard module 300a.

While the present invention has been described with reference to a TV remote controller, it will be appreciated that the present invention can be applied to any remote controller for, for example, audio systems, video cassette recorders, digital versatile disc (DVD) players.

Also, the term “key input”, as used in this application, is not limited to data which is entered using actual keys. Rather this term is used to mean data input either by actual keys or by other devices, such as, but not by way of limitation, a mouse, a joy stick, a touch pad, etc.

As described above, a modular remote controller according to the present invention can be constructed by connecting a main remote controller performing a basic function with an appropriate extension module for a particular function according to the user's choice. The main remote controller may be independently used only for the basic function or may be used in connection with appropriate extension modules according to the desired function.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A remote controller comprising:
a key input portion having a plurality of instruction keys with which an instruction to remotely control an electronic apparatus is input;
a controller which generates a first control signal in response to the instruction input from the key input portion and outputs one of the first control signal and a second control signal which is externally input, as a remote control signal; and
a wireless data transmitter which wirelessly transmits the remote control signal to the electronic apparatus.

2. The remote controller of claim 1, wherein the remote controller comprises a plurality of interface ports for receiving the second control signal.

3. The remote controller of claim 2, wherein the plurality of interface ports support one interfacing protocol selected from the group consisting of USB (Universal Serial Bus), CompactFlash, Bluetooth, and RS232C.

4. A multi-connection type remote controller extension module comprising:
a key input portion having at least one instruction key;
an input port which externally receives a first control signal for remotely controlling an electronic apparatus;
a functional circuit which generates a second control signal for remotely controlling the electronic apparatus by performing its specific function in response to an instruction input from the key input portion and outputs one of the first control signal and the second control signal; and
an output port which externally outputs an output signal of the functional circuit.

5. The multi-connection type remote controller extension module of claim 4, wherein the first control signal is generated from another remote controller extension module connected to the multi-connection type remote controller extension module.

6. The multi-connection type remote controller extension module of claim 4, wherein the output port is selectively coupled to one of a remote controller which wirelessly transmits the output signal to the electronic apparatus, and another remote controller extension module which receives the output signal as the first control signal.

7. The multi-connection type remote controller extension module of claim 6, wherein the functional circuit comprises an interface hub which receives the first control signal generated from the another remote controller extension module and outputs one of the first and second control signals for interfacing with the remote controller and the another remote controller extension module.

8. The multi-connection type remote controller extension module of claim 7, wherein each of the interface hub and the input and output ports supports one interfacing protocol selected from the group consisting of USB (Universal Serial Bus), CompactFlash, Bluetooth, and RS232C.

9. A single-connection type remote controller extension module comprising:
a key input portion having at least one instruction key;
a functional circuit which generates a control signal for remote controlling an electronic apparatus by performing its specific function in response to an instruction input from the key input portion; and
an output port which externally outputs the control signal.

10. The single-connection type remote controller extension module of claim 9, wherein the output port is selectively coupled to one of a remote controller which wirelessly transmits an output signal to the electronic apparatus, and a multi-connection type remote controller extension module which transmits the output signal to the remote controller.

11. The single-connection type remote controller extension module of claim 10, wherein the functional circuit comprises an interface circuit for interfacing with the remote controller and the multi-connection type remote controller extension module.

12. The single-connection type remote controller extension module of claim 11, wherein each of the output port and the interface circuit supports one interfacing protocol selected from the group consisting of USB (Universal Serial Bus), CompactFlash, Bluetooth, and RS232C.

13. A modular remote controller comprising:
a main remote controller which generates a remote control signal for remotely controlling an electronic apparatus in response to one of an internal control signal internally generated in response to a key input, and an external control signal; and
a plurality of remote controller extension modules which are selectively coupled to the main remote controller and generates the external control signal.

14. The modular remote controller of claim 13, wherein the main remote controller comprises:
a key input portion which receives a key input;
an interface port electrically coupled to the remote control extension module;
a controller which generates the internal control signal in response to the key input and generates the remote control signal in response to one of the internal control signal and the external control signal; and
a wireless data transmitter which wirelessly transmits the remote control signal to the electronic apparatus.

15. The modular remote controller of claim 13, wherein the plurality of remote controller extension modules comprise a multi-connection type remote controller extension module capable of being coupled to both of the main remote controller and another remote controller extension module, and a single connection type remote controller extension module capable of being coupled to one of the main remote controller and another remote controller extension module.

16. The modular remote controller of claim 15, wherein the multi-connection type remote controller extension module comprises:
a key input portion having at least one instruction key;
an input port which receives an external control signal from the another remote controller extension module coupled to the same;
a functional circuit which generates the internal control signal for remote controlling the electronic apparatus by performing its specific function in response to an instruction input from the key input portion and outputs one of the internal control signal and the external control signal; and
an output port which externally outputs an output signal of the functional circuit.

17. The modular remote controller of claim 15, wherein the single-connection type remote controller extension module comprises:
a key input portion having at least one instruction key;
an output port electrically coupled to one of the main remote controller and another remote controller extension module; and
a functional circuit which generates a control signal for remote controlling an electronic apparatus by performing its specific function in response to an instruction input from the key input portion.

18. The modular remote controller of claim 17, wherein the functional circuit comprises an interface circuit which transmits the control signal as the external control signal to one of the main remote controller and the multi-connection type remote controller coupled to the same.

19. The modular remote controller of claim 17, wherein the output port supports one interfacing protocol selected from the group consisting of USB (Universal Serial Bus), CompactFlash, Bluetooth, and RS232C.

20. A method for controlling a remote controller, the method comprising:
determining whether a key input has been generated in the remote controller by a key input portion of the remote controller;
generating a first control signal for remotely controlling an electronic apparatus in response to the key input if a key input has been generated;
determining whether a second control signal for remotely controlling the electronic apparatus has been input from a remote controller extension module externally attached to the remote controller;
outputting one of the first and second control signals as a remote control signal; and
wirelessly transmitting the remote control signal to the electronic apparatus.

21. A method for controlling a multi-connection type remote controller, the method comprising:
determining whether a key input has been generated by a key input portion of the multi-connection type remote controller;
generating a first control signal for remotely controlling an electronic apparatus in response to the key input if a key input has been generated;
determining whether a second control signal for remotely controlling the electronic apparatus has been input from another remote controller extension module externally attached to the multi-connection type remote controller;
outputting one of the first and second control signals to the remote controller if the multi-connection type remote controller module is directly attached to a remote controller of the electronic apparatus; and
outputting one of the first and second control signals to the another remote controller extension module if the multi-connection type remote controller module is connected to the remote controller via the another remote controller extension module.

22. A method for controlling a single-connection type remote controller extension module, the method comprising:
determining whether a key input has been generated by a key input portion of the single-connection type remote controller extension module;
generating a control signal for remote controlling an electronic apparatus in response to the key input if a key input has been generated;
outputting the control signal to the remote controller if the single-connection type remote controller is directly connected to a remote controller of the electronic apparatus; and
outputting the control signal to another remote controller extension module if the single-connection type remote controller is connected to the remote controller via the another remote controller extension module.
